(19) United States
(12) Patent Application Publication
(10) Pub. No.: US 2013/0252138 A1
(43) Pub. Date: Sep. 26, 2013

(54) PT/GRAPHENE CATALYST, PREPARATION METHOD AND USE THEREOF

(71) Applicants: Mingjie Zhou, Guangdong (CN); Linglong Zhong, Guangdong (CN); Yaobing Wang, Guangdong (CN)

(72) Inventors: Mingjie Zhou, Guangdong (CN); Linglong Zhong, Guangdong (CN); Yaobing Wang, Guangdong (CN)

(73) Assignee: OCEAN'S KING LIGHTING SCIENCE & TECHNOLOGY CO.,LTD, Guangdong (CN)

(21) Appl. No.: 13/990,154

(22) PCT Filed: Dec. 29, 2010
(86) PCT No.: PCT/CN10/80457

§ 371 Date: May 29, 2013

(51) Int. Cl. H01M 4/92

(52) U.S. Cl. CPC H01M 4/926
USPC 429/524; 502/5

(57) ABSTRACT

A Pt/graphene catalyst comprises graphene as carrier, and Pt loaded on the graphene. The use of graphene as carrier for the catalyst takes advantage of the ion effect and two-dimensional ductility of graphene, which increases the stability of the catalyst. The catalyst is prepared by a reverse micelles system method which provides a micro-environment (i.e. water-in-oil microemulsion), so that the particle size of the resulting nano-particles can be regulated easily and is more uniformly distributed. The use of the catalyst in electrochemostry is also disclosed.

### FIELD OF THE INVENTION

The present invention relates to a field of electrochemical energy, and more particularly relates to Pt/graphene catalyst which is used in a proton exchange membrane fuel cell. The present invention also relates to a preparation method and a use of Pt/graphene catalyst.

### BACKGROUND OF THE INVENTION

Proton exchange membrane fuel cell (PEMFC) is a new generation of power generation device using hydrogen as the fuel, besides the general advantages of the fuel cell (high energy conversion efficiency and environmental friendliness), it has prominent advantages of high specific power, high specific energy, low working temperature, fast start-up and long life at room temperature, which make the PEMFC the most promising fuel cell.

Electrocatalysts of PEMC is a key factor which restricts the commercialization, the study on electrocatalysts dominates the research on PMEC. As pointed out by Lippard who is the dean of MIT's chemistry department in reviewing the development of the chemistry in the 20^{th} century that the biggest regret of the 20^{th} century chemistry was the failure to develop an excellent fuel cell catalyst.

The preparation method of the catalyst has great influence on the particle size and crystalline state of Pt catalyst, the present method reported for preparation of Pt/graphene catalyst mainly including inorganic colloid method, impregnation method, sol-gel method, and precipitation method, etc. Catalyst prepared by these methods has the problems of poor particle dispersion, unevenness of the particle diameter and relatively harsh reaction condition. As the preparation process determines the composition and structure of the catalyst, thereby affects its catalytic performance, the research on the method and process of preparation of the catalyst is very important.

The theory of graphene has been studied for more than 60 years, it has been widely used to study the performance of the different structure of the carbonaceous material. In Science, 2009, vol 324: 1530, Geim pointed out that graphene is a carbon material having less than 10 layers of the layered structure of the graphite molecules, it has higher specific surface area (the theoretical specific surface area of graphene is up to 2620 m²/g) and can provide more life load position. Meanwhile, graphene exhibits strong quantum effects, and has good electronic conductivity. According to the first principle calculation, Pt group can be stably loaded on the graphene, the absorption of carbon monoxide or hydrogen on the metal platinum particles will be reduced because of the presence of the graphene which would facilitate the reaction in the fuel cell. Therefore, graphene can be used as a good carbon carrier.

### SUMMARY OF THE INVENTION

Based on the problems mentioned above, one object of the present invention is to provide a preparation method of a Pt/graphene catalyst which includes the steps of:

1. Preparation of a graphite oxide: a graphite oxide is prepared by using graphite powder according to modified Hummers method.

2. Preparation of a graphene oxide solution: the prepared graphite oxide is added into water, and then ultrasonically dispersed to form a graphene oxide solution with uniformly dispersed monolithic layer.

3. Preparation of a reverse micellar system: a mixing system containing surfactant (anionic surfactant or cationic surfactant, such as methyl benzene sulfonate, sodium dodecyl benzene sulfonate, aliphatic sulfates, quaternary ammonium salts, etc.), cosurfactant (such as n-octanol, n-nonyl alcohol, n-heptanol, n-hexyl alcohol), oil phase (such as cyclohexane) and chloroplatinic acid aqueous solution with the molar concentration of 0.04 mol/L is prepared at room temperature, the mixing system is ultrasonically dispersed to form a uniform and stable reverse micellar system; the mass ratio of the surfactant, the cosurfactant and the oil phase is 10:7:1.

4. Formation of a precursor: the prepared graphene oxide solution is slowly added dropwise into the reverse micellar system.

5. Reduction of the precursor: in 80° C. water bath, excess amount of reducing agent (such as hydrazine hydrate or sodium borohydride, the molar amount of the reducing agent is 3 to 10 times of the molar amount of the chloroplatinic acid) is added into the reverse micelle system, the chloroplatinic acid and the graphene oxide are reduced to Pt and the graphene, an emulsion containing Pt and graphene is prepared; H₂PtCl₆ is now used as an example, KBH₄ is used as a reducing agent, the reaction equation is:

H₂PtCl₆+KBH₄→Pt+H₂↑+2HCl+KCl+BCl₃

6. Demulsification: a demulsifier (such as acetone or ethanol, the adding volume of the demulsifier is 20% to 50% of the adding volume of the cyclohexane) is added into the emulsion under ultrasonic vibration, Pt is loaded on the graphene carrier to form a mixing system.

7. Filtering, washing and drying: the demulsified mixing system is vacuum filtrated, and then sequentially washed and filtered with ethanol and deionized water for several times, the filtered graphene loaded with Pt is dried at the temperature of 70° C. under vacuum condition for 2 hours to obtain the Pt/graphene catalyst.

The Pt/graphene catalyst prepared by the method contains graphene as a carrier, Pt is loaded on the graphene.

The Pt/graphenene prepared according to the present invention can be used in the field of proton exchange membrane fuel cell.

The Pt/graphene catalyst of the present invention uses graphene as carrier and takes advantage of the ion effect and two dimensional ductility of the graphene, which increases the stability of the catalyst. The reverse micelles system provides a micro-environment (water-in-oil microemulsion), which is an idea place for particle synthesis, the particle size of the nano-particles prepared according to the method can be regulated easily and is more uniformly distributed.

### BRIEF DESCRIPTION OF THE DRAWINGS

FIG. 1 is a flow chart of the preparation of Pt/graphene catalyst according to the present invention.

FIG. 2 is an electrocatalytic performance test chart of the membrane electrode of the Pt/graphene catalyst prepared in Example 1 and the Pt/C catalyst.

### DETAILED DESCRIPTION OF THE EMBODIMENTS

The present invention provides a preparation method of Pt/graphene catalyst which is used in the proton exchange membrane fuel cell, wherein the loading amount of Pt is 5˜80 w %, the use of graphene as carrier for the catalyst takes advantage of the ion effect and two-dimensional ductility of graphene, which increases the stability of the catalyst.

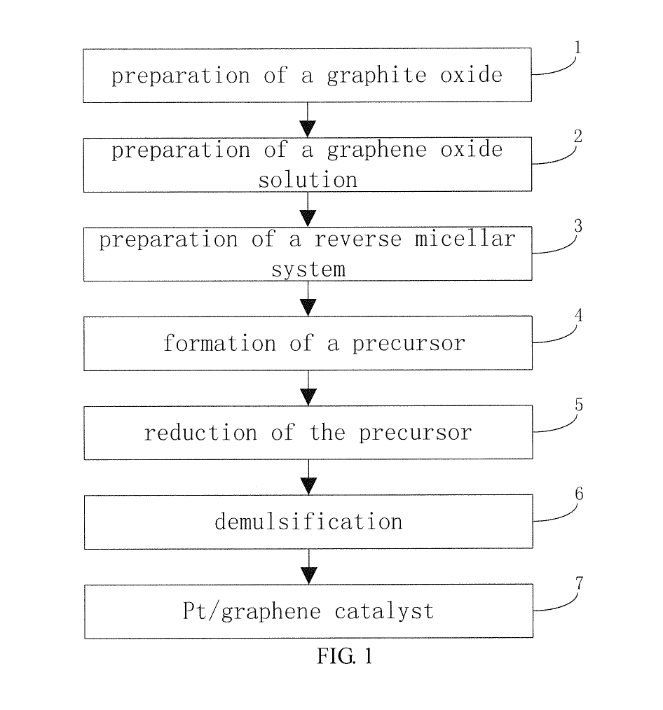

Referring to FIG. 1, the preparation method of the Pt/graphene catalyst includes:

1. Preparation of a graphite oxide: a graphite oxide is prepared by using graphite powder according to improved Hummers method.

2. Preparation of a graphene oxide solution: the prepared graphite oxide is added into water, and then ultrasonically dispersed to form a graphene oxide solution with uniformly dispersed monolithic layer.

3. Preparation of a reverse micellar system: A mixing system containing surfactant (Anionic surfactant or cationic surfactant, such as methyl benzene sulfonate, sodium dodecyl benzene sulfonate, aliphatic sulfates, quaternary ammonium salts, etc.), cosurfactant (such as n-octanol, n-nonyl alcohol, n-heptanol, n-hexyl alcohol), oil phase (such as cyclohexane) and chloroplatinic acid aqueous solution with the molar concentration of 0.04 moL/L is prepared at room temperature, the mixing system is ultrasonically dispersed to form a uniform and stable reverse micellar system; the mass ratio of the surfactant, the cosurfactant and the oil phase is 10:7:1.

4. Formation of a precursor: the prepared graphene oxide solution is slowly added dropwise into the reverse micellar system.

5. Reduction of the precursor: in 80° C. water bath, excess amount of reducing agent (such as hydrazine hydrate or sodium borohydride, the molar amount of the reducing agent is 3 to 10 times that of the molar amount of the chloroplatinic acid) is added into the reverse micelle system, the chloroplatinic acid and the graphene oxide are reduced to Pt and the graphene, a emulsion containing Pt and graphene is prepared and the mass ratio of Pt and graphene is 1:10; H₂PtCl₆ is now used as an example, KBH₄ is taken as a reducing agent, the reaction equation is:

H₂PtCl₆+KBH₄→Pt+H₂↑+2HCl+KCl+BCl₃

6. Demulsification: the demulsifier (such as acetone or ethanol, the adding volume of the demulsifier is 20 to 50% of the adding volume of the cyclohexane) is added into the emulsion under ultrasonic vibration, Pt is loaded on the graphene carrier to form a mixing system.

7. Filtering, washing and drying: the demulsified mixing system is vacuum filtrated, and then sequentially washed and filtered with ethanol and deionized water for several times, the filtered graphene loaded with Pt is dried at the temperature of 70° C. under vacuum condition for 2 hours to obtain the Pt/graphene catalyst.

Wherein, the preparation of graphite oxide comprises:

1. The graphite powder, potassium persulfate and phosphorus pentoxide are added into a concentrated sulfuric acid at a temperature of 80° C., and then stirred uniformly, cooled for more than 6 hours, washed to neutral, dried to obtain a sample;

2. The dried sample is added into 200 to 250 mL of concentrated sulfuric acid, then potassium permanganate is added, the mixture is heat preserved at a temperature of 0 to 20° C. for 5 to 60 minutes, then maintained at a temperature of 35° C. in an oil bath for 1 to 2 hours, deionized water containing hydrogen peroxide is slowly added to obtain a mixture;

3. The mixture is hot filtrated when the color of the mixture becomes bright yellow, and then washed with hydrochloric acid and filtered, the mixture is vacuum dried at a temperature of 60° C. for 48 hours to obtain the graphite oxide.

The Pt/graphene catalyst prepared according to the above method contains graphene as a carrier and Pt is loaded on the graphene.

The prepared Pt/graphene in the present invention can be used in the field of proton exchange membrane fuel cell.

In the Pt/graphene catalyst of the present invention, the use of graphene as carrier takes advantage of the ion effect and two-dimensional ductility of graphene, which increases the stability of the catalyst. The use of the reverse micelles system provides a micro-environment (i.e. water-in-oil microemulsion), which is an idea place for the particle synthesis; the particle size of the resulting nano-particles can be regulated easily and is more uniformly distributed.

The preferred embodiments of the present invention are further described in connection with the accompanying drawings.

### Example 1

1. Preparation of a graphite oxide: a graphite oxide was prepared according to modified Humers method. The specific steps included: 20 g of 50 mesh graphite powder, 10 g of potassium persulfate and 10 g of phosphrous were added into concentrated sulfuric acid at a temperature of 80° C., and then the mixture was stirred uniformly, cooled for more than 6 hours, washed to neutral and dried to obtain a sample. The dried sample was added into 230 mL of concentrated sulfuric acid at a temperature of 0° C., then 60 g of potassium permanganate was added, the mixture was maintained below 20° C. for 30 minutes, after being maintained in the oil bath at a temperature of 35° C. for 2 hours, 920 mL of deionized water was slowly added. After 15 minutes, 2.8 L of deionized water (containing 50 mL of hydrogen peroxide with the concentration of 30%) was added, the mixture was hot filtrated when the color of the mixture became bright yellow, and then washed with 5 L of hydrochloric acid with the concentration of 10%, filtrated, vacuum dried at a temperature of 60° C. for 48 hours to obtain graphite oxide.

2. Preparation of a graphene oxide solution: 0.5 g of the graphite oxide was added into 200 mL of water, and ultrasonically dispersed to form a graphene oxide solution with uniformly dispersed monolithic layer;

3. Preparation of a reverse micellar system: at room temperature, sodium dodecyl benzene sulfonate, n-octanol and cyclohexane were mixed according to a mass ratio of 100:70:10, sodium dodecyl benzene sulfonate was added into water according to a molar ratio of sodium dodecyl benzene sulfonate to water of 1:7, ultrasonically vibrated for 30 minutes, 0.04 moL/L of chloroplatinic acid solution was slowly added dropwise into the mixed solution, ultrasonically vibrated for 30 minutes to form a transparent reverse micellar system.

4. Formation of a precursor: the prepared graphene oxide solution was slowly added dropwise into the reverse micellar system, ultrasonically vibrated for 30 minutes. The mass ratio of Pt and graphene was 1:10.

5. Reduction of the precursor: in water bath at a temperature of 80° C., excess amount of sodium borohydride was added into the reverse micellar system, then ultrasonically vibrated for 2 hours, such that the graphene oxide and the chloroplatinic acid were reduced.

6. Demulsification: 30 mL of the demulsifier of acetone was added into the above system under ultrasonically vibration, and the system was then stood until the system was stratified.

7. Filtering, washing and drying: the solution was filtered, the filtering cake was washed with ethanol solution and deionized water for several times, the catalyst was vacuum dried at a temperature of 70° C. for 2 hours to obtain a Pt/graphene catalyst.

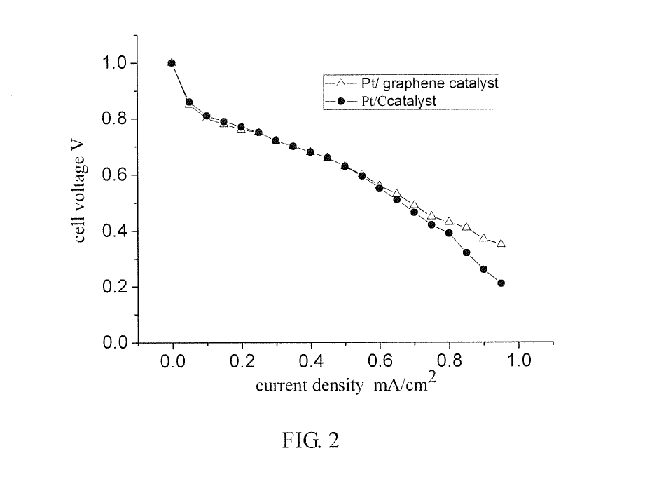

FIG. 2 was the electrocatalytic performance test chart of the membrane electrode of the Pt/graphene catalyst prepared in Example 1 and the Pt/C catalyst. The preparation of the membrane electrode included the following steps: the carbon paper was evenly coated with the Pt/graphene catalyst obtained in example 1 to form an electrode, then two electrodes and the Nafion proton exchange membrane (DuPont, USA) were deposited at a temperature of 140° C. under a pressure of 0.3 Mpa to form a membrane electrode. Test conditions of the electrocatalytic performance of the membrane electrode were shown as follows: the membrane electrode was loaded within the proton exchange membrane monomer battery, the fuel cell tester was connected to the battery, the effective area of the membrane electrode was 4 cm², pure hydrogen and pure oxygen were fed while testing. The Pt/C catalyst was also prepared into membrane electrode using the same method and it was tested, it can be seen that the catalytic performance of the Pt/graphene was better at the higher current density.

### Example 2

1. Preparation of a graphite oxide: a graphite oxide was prepared according to modified Humers method. The specific steps included: 20 g of 50 mesh graphite powder, 10 g of potassium persulfate and 10 g of phosphrous were added into concentrated sulfuric acid at a temperature of 80° C., and then the mixture was stirred uniformly, cooled for more than 6 hours, washed to neutral and dried to obtain a sample. The dried sample was added into 230 mL of concentrated sulfuric acid at a temperature of 0° C., then 60 g of potassium permanganate was added, the mixture was maintained below 20° C. for 30 minutes, after being maintained in the oil bath at a temperature of 35° C. for 1 hours, 920 mL of deionized water was slowly added. After 15 minutes, 2.8 L of deionized water (containing 50 mL of hydrogen peroxide with the concentration of 30%) was added, the mixture was hot filtrated when the color of the mixture became bright yellow, and then washed with 5 L of hydrochloric acid with the concentration of 10%, filtrated, vacuum dried at a temperature of 60° C. for 48 hours to obtain graphite oxide.

2. Preparation of a graphene oxide solution: 0.5 g of the graphite oxide was added into 200 mL of water, and ultrasonically dispersed to form a graphene oxide solution with uniformly dispersed monolithic layer;

3. Preparation of a reverse micellar system: at room temperature, methyl benzene sulfonate, n-octanol and cyclohexane were mixed according to a mass ratio of 100:70:10, methyl benzene sulfonate was added into water according to a molar ratio of sodium dodecyl benzene sulfonate to water of 1:7, ultrasonically vibrated for 30 minutes, 0.04 moL/L of chloroplatinic acid solution was slowly added dropwise into the mixed solution, ultrasonically vibrated for 30 minutes to form a transparent reverse micellar system.

4. Formation of a precursor: 10%-60%, the prepared graphene oxide solution was slowly added dropwise into the reverse micellar system, ultrasonically vibrated for 30 minutes. The mass ratio of Pt and graphene was 1:10.

5. Reduction of the precursor: in water bath at a temperature of 80° C., excess amount of sodium borohydride was added into the reverse micellar system, then ultrasonically vibrated for 2 hours, such that the graphene oxide and the chloroplatinic acid were reduced.

6. Demulsification: 30 mL of the demulsifier of acetone was added into the above system under ultrasonically vibration, and the system was then stood until the system was stratified.

7. Filtering, washing and drying: the solution was filtered, the filtering cake was washed with ethanol solution and deionized water for several times, the catalyst was vacuum dried at a temperature of 70° C. for 2 hours to obtain a Pt/graphene catalyst.

### Example 3

1. Preparation of a graphite oxide: a graphite oxide was prepared according to modified Humers method. The specific steps included: 20 g of 50 mesh graphite powder, 10 g of potassium persulfate and 10 g of phosphrous were added into concentrated sulfuric acid at a temperature of 80° C., and then the mixture was stirred uniformly, cooled for more than 6 hours, washed to neutral and dried to obtain a sample. The dried sample was added into 250 mL of concentrated sulfuric acid at a temperature of 0° C., then 60 g of potassium permanganate was added, the mixture was maintained below 20° C. for 60 minutes, after being maintained in the oil bath at a temperature of 35° C. for 2 hours, 920 mL of deionized water was slowly added. After 15 minutes, 2.8 L of deionized water (containing 50 mL of hydrogen peroxide with the concentration of 30%) was added, the mixture was hot filtrated when the color of the mixture became bright yellow, and then washed with 5 L of hydrochloric acid with the concentration of 10° A, filtrated, vacuum dried at a temperature of 60° C. for 48 hours to obtain graphite oxide.

2. Preparation of a graphene oxide solution: 0.5 g of the graphite oxide was added into 200 mL of water, and ultrasonically dispersed to form a graphene oxide solution with uniformly dispersed monolithic layer;

3. Preparation of a reverse micellar system: at room temperature, methyl benzene sulfonate, n-octanol and cyclohexane were mixed according to a mass ratio of 100:70:10, methyl benzene sulfonate was added into water according to a molar ratio of sodium dodecyl benzene sulfonate to water of 1:7, ultrasonically vibrated for 30 minutes, 0.04 moL/L of chloroplatinic acid solution was slowly added dropwise into the mixed solution, ultrasonically vibrated for 30 minutes to form a transparent reverse micellar system.

4. Formation of a precursor: 10%-60%, the prepared graphene oxide solution was slowly added dropwise into the reverse micellar system, ultrasonically vibrated for 30 minutes. The mass ratio of Pt and graphene was 1:10.

5. Reduction of the precursor: in water bath at a temperature of 80° C., excess amount of hydrazine hydrate solution was added into the reverse micellar system, then ultrasonically vibrated for 2 hours, such that the graphene oxide and the chloroplatinic acid were reduced.

6. Demulsification: 30 mL of the demulsifier of acetone was added into the above system under ultrasonically vibration, and the system was then stood until the system was stratified.

7. Filtering, washing and drying: the solution was filtered, the filtering cake was washed with ethanol solution and deionized water for several times, the catalyst was vacuum dried at a temperature of 70° C. for 2 hours to obtain a Pt/graphene catalyst.

### Example 4

1. Preparation of a graphite oxide: a graphite oxide was prepared according to modified Humers method. The specific steps included: 20 g of 50 mesh graphite powder, 10 g of potassium persulfate and 10 g of phosphrous were added into concentrated sulfuric acid at a temperature of 80° C., and then the mixture was stirred uniformly, cooled for more than 6 hours, washed to neutral and dried to obtain a sample. The dried sample was added into 240 mL of concentrated sulfuric acid at a temperature of 0° C., then 60 g of potassium permanganate was added, the mixture was maintained below 20° C. for 40 minutes, after being maintained in the oil bath at a temperature of 35° C. for 2 hours, 920 mL of deionized water was slowly added. After 15 minutes, 2.8 L of deionized water (containing 50 mL of hydrogen peroxide with the concentration of 30%) was added, the mixture was hot filtrated when the color of the mixture became bright yellow, and then washed with 5 L of hydrochloric acid with the concentration of 10%, filtrated, vacuum dried at a temperature of 60° C. for 48 hours to obtain graphite oxide.

2. Preparation of a graphene oxide solution: 0.5 g of the graphite oxide was added into 200 mL of water, and ultrasonically dispersed to form a graphene oxide solution with uniformly dispersed monolithic layer;

3. Preparation of a reverse micellar system: at room temperature, sodium dodecyl benzene sulfonate, n-octanol and cyclohexane were mixed according to a mass ratio of 100:70:10, sodium dodecyl benzene sulfonate was added into water according to a molar ratio of sodium dodecyl benzene sulfonate to water of 1:8, ultrasonically vibrated for 30 minutes, 0.04 moL/L of chloroplatinic acid solution was slowly added dropwise into the mixed solution, ultrasonically vibrated for 30 minutes to form a transparent reverse micellar system.

4. Formation of a precursor: 10%-60%, the prepared graphene oxide solution was slowly added dropwise into the reverse micellar system, ultrasonically vibrated for 30 minutes. The mass ratio of Pt and graphene was 1:10.

5. Reduction of the precursor: in water bath at a temperature of 80° C., excess amount of sodium borohydride was added into the reverse micellar system, then ultrasonically vibrated for 2 hours, such that the graphene oxide and the chloroplatinic acid were reduced.

6. Demulsification: 30 mL of the demulsifier of acetone was added into the above system under ultrasonically vibration, and the system was then stood until the system was stratified.

7. Filtering, washing and drying: the solution was filtered, the filtering cake was washed with ethanol solution and deionized water for several times, the catalyst was vacuum dried at a temperature of 70° C. for 2 hours to obtain a Pt/graphene catalyst.

Although the invention has been described in language specific to structural features and/or methodological acts, it is to be understood that the invention defined in the appended claims is not necessarily limited to the specific features or acts described. Rather, the specific features and acts are disclosed as sample forms of implementing the claimed invention.

1. A preparation method of a Pt/graphene catalyst, comprising the steps of:
performing an oxidation reaction with graphite power according to a Hummers method to obtain graphite oxide;
adding the graphite into water and then ultrasonically dispersing to form a graphene oxide solution with uniformly dispersed monolithic layer;
preparing a reverse micellar system containing surfactant, co-surfactant, oil phase, and chloroplatinic acid aqueous solution at room temperature;
adding the graphite oxide solution into the reverse micellar system dropwise, and adding catalyst dropwise to perform a reduction reaction under a water bath heating condition to obtain an emulsion containing Pt and graphene;
adding demulsifier into the emulsion dropwise to load Pt on the graphene carrier; and
filtering, washing, and drying the graphene loaded with the Pt to obtain the Pt/graphene catalyst.

2. The preparation method according to claim 1, wherein the steps of preparing the graphite oxide comprises:
adding graphite powder, potassium persulfate and phosphrous pentoxide into a concentrated sulfuric acid at a temperature of 80° C., stirring uniformly and cooling for more than six hours, washing to neutral, drying to obtain a sample;
adding the dried sample into 200 to 250 mL of concentrated sulfuric acid, then adding potassium permanganate, heat preserving at a temperature of 0 to 20° C. for 5 to 60 minutes, maintaining at a temperature of 35° C. in an oil bath for 1 to 2 hours, slowly adding deionized water containing hydrogen peroxide to obtain a mixture; and
hot filtrating the mixture when the color of the mixture becomes bright yellow, washing with hydrochloric acid and then filtering, drying under vacuum condition at a temperature of 60° C. for 48 hours to obtain the graphite oxide.

3. The preparation method according to claim 2, wherein the mass ratio of the graphite powder, the potassium persulfate and the phosphrous pentoxide is 2:1:1.

4. The preparation method according to claim 2, wherein an adding amount of the potassium permanganate is 3 times of the adding amount of the graphite powder, the concentration of the hydrogen peroxide is wt. 30%.

5. The preparation method according to claim 1, wherein the surfactant is selected from the group consisting of methyl benzene sulfonate, sodium dodecylbenzene sulfonate, aliphatic sulfate and aliphatic quaternary ammonium salts; the co-surfactant is selected from the group consisting of n-octanol, n-nonyl alcohol, n-heptanol, and n-hexyl alcohol; the oil phase is cyclohexane; the molar concentration of the chloroplatinic acid aqueous solution is 0.04 mol/L; the mass ratio of the surface active agent, the cosurfactant, and the oil phase is 10:7:1.

6. The preparation method according to claim 1, wherein in the emulsion containing Pt and graphene, the mass ratio of Pt to graphene is 1:10.

7. The preparation method according to claim 1, wherein the reducing agent is hydrazine hydrate or sodium borohydride, the using amount of reducing agent is 3 to 10 times of the amount of chloroplatinic acid.

8. The preparation method according to claim 1, wherein the demulsifier is acetone or ethanol.

9. A Pt/graphene catalyst, being prepared according to claim 1, wherein graphene is a carrier, and Pt is loaded on the graphene.

10. A proton exchange membrane fuel cell, comprising the Pt/graphene catalyst according to claim 9.
